(19) United States
(12) Patent Application Publication
(10) Pub. No.: US 2015/0117515 A1
(43) Pub. Date: Apr. 30, 2015

(54) Layered Encoding Using Spatial and Temporal Analysis

(71) Applicant: Microsoft Corporation, Redmond, WA (US)

(72) Inventors: Jingjing Fu, Beijing (CN); Yan Lu, Beijing (CN); Shipeng Li, Palo Alto, CA (US); Dan Miao, Tianjin (CN)

(73) Assignee: Microsoft Corporation, Redmond, WA (US)

(21) Appl. No.: 14/063,585

(22) Filed: Oct. 25, 2013

(51) Int. Cl. H04N 19/103; H04N 19/172; H04N 19/167

(52) U.S. Cl. CPC H04N 19/00018; H04N 19/00248; H04N 19/00266
USPC 375/240.02

(57) ABSTRACT

In some examples, a layered encoding component and a layered decoding component provide for different ways to encode and decode, respectively, video streams transmitted between devices. For instance, in encoding a video stream, video frames may be analyzed across multiple video frames to determine temporal characteristics, and analyzed spatially within a single given video frame. Further, based at partly on the analysis of the video frames, some video frames may be encoded with a first encoding and portions of other video frames may be encoded using a second layer encoding, where the second layer encoding may use a different type of encoding for different portions of a single given video frame. To decode an encoded video stream, both the base layer encoded video frames and the second layer encoded video frames may be transmitted, decoded, and combined at a destination device into a reconstructed video stream.

### BACKGROUND

Remote computing often involves the remote use of a display and the transfer of data to allow a remote display to be displayed locally. Other computing environments may also employ the transfer of visual data, for example video streaming, gaming, remote desktops, and remote video conferencing, among others. To address solutions for transferring visual information from which an image may be rendered, several compression techniques and video codecs have been developed and standardized. However, traditional video codecs often apply to entire frames of a video stream and are unable to maintain high image quality when video frames include multiple different types of image content.

### SUMMARY

The techniques and systems described herein present various implementations of layered screen video coding and decoding. For example, in one implementation applied to the transmission of a video stream, video screen frames may be analyzed across multiple video frames to determine temporal characteristics, and analyzed spatially within a single given video frame. In this example, based at least in part on the analysis of the video frames, some video frames may be encoded with a first, or base layer encoding, and portions of other video frames may be encoded using a second layer encoding, where the second layer encoding may use a different type of encoding for different portions of a single given video frame. Further, both the base layer encoded video frames and the second layer encoded video frames may be transmitted, decoded, and combined at a destination device into a reconstructed video stream.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example computing environment in which a layered encoding component and layered decoding component may be implemented.

FIG. 2 is a flow diagram depicting a method to encode a series of video frames into multiple layers in accordance with some implementations.

FIG. 3 is a flow diagram depicting a method to decode, into a video stream, a series of video frames that have been encoded into multiple layers in accordance with some implementations.

FIG. 4 depicts components within a second layer encoding module of a layered encoding component in accordance with some implementations.

FIG. 5 depicts components within a base layer encoding module of a layered encoding component in accordance with some implementations.

FIG. 6 illustrates different types of visual data within a video frame in accordance with the implementations.

FIG. 7 illustrates luminance histograms corresponding to types of image blocks in accordance with some implementations.

FIG. 8 is a flow diagram depicting a method to analyze a video frame within spatial and temporal domains in accordance with some implementations.

FIG. 9 illustrates a series of video frames within the context of a temporal domain analysis in accordance with some implementations.

FIG. 10 illustrates a luminance histogram for a block within a video frame within the context of a spatial analysis in accordance with some implementations.

FIG. 11 illustrates a mapping from a block of pixels into an index map used in a second layer encoding in accordance with some implementations.

FIG. 12 illustrates a division of a sequence of video frames into multiple layers of encoded video frames in accordance with some implementations.

FIG. 13 illustrates a merging of different layers of video frames into a reconstructed video stream in accordance with some implementations.

FIG. 14 illustrates a computer system that may be configured to implement a layered encoding component and layered decoding component, according to some implementations.

### DETAILED DESCRIPTION

The techniques and systems described herein are directed to various implementations of a layered encoding component and a layered decoding component. The layered encoding component, or simply “encoding component,” provides a variety of ways for encoding a stream of image data for efficient and compact transmissions from a source device to a destination device. The layered decoding component, or simply “decoding component,” works to decode image data encoded with the layered encoding component. For example, the layered decoding component may receive different encoded layers of a video stream transmitted from a source device and decode the differently encoded layers to generate a reconstructed video stream for display on a target device. Together, the layered encoding component and layered decoding component may be used in streaming video between devices across a network while maintaining high video quality without interruptions in displaying the video.

In one example, a user at a local computer may interact with a remote computer. In this example of remote usage, the remote computer may display a user interface and the user at the local computer may be interested in interacting with the user interface. In order for the user to see any update of the user interface, a video stream that includes a series of multiple individual video frames may be encoded and transmitted from the remote computer to the local computer. In this environment, the layered encoding component on the remote computer and the layered decoding component on the local computer may provide the user with the ability to see the remote user interface on their local computer such that a local display of the video stream on the remote device maintains a high level of image quality with a performance level that avoids interruptions in the video stream due to encoding or decoding.

In different implementations, to maintain high image quality, the layered encoding component may encode a video stream without downsampling. For example, the layered encoding component may identify which blocks or regions of a given video frame that have a greater impact on video quality based on an analysis of the contents of the video frame, and then encode those blocks or regions using a second layer encoding. In some implementations, the second layer encodings are defined to maintain quality for the blocks or regions with a greater impact on video image quality. In this example, encoding techniques that may be more computationally intensive would not impact overall processing time because only a portion of a given video frame determined to be encoded into a second layer is encoded. In this way, a video stream may be encoded, transmitted, and decoded to provide a reconstructed video stream that maintains a high image quality, and in which the reconstructed video may be displayed smoothly and without interruptions or stalls.

In other examples, the layered encoding component and layered decoding component may be used in different computing environments, such as video streaming media content, screen sharing, web or video conferencing, online training, and the like. In general, the layered encoding component and layered decoding component may be implemented in any computing environment where a series of image frames are transmitted from one computing device to another computing device.

### Example Implementations

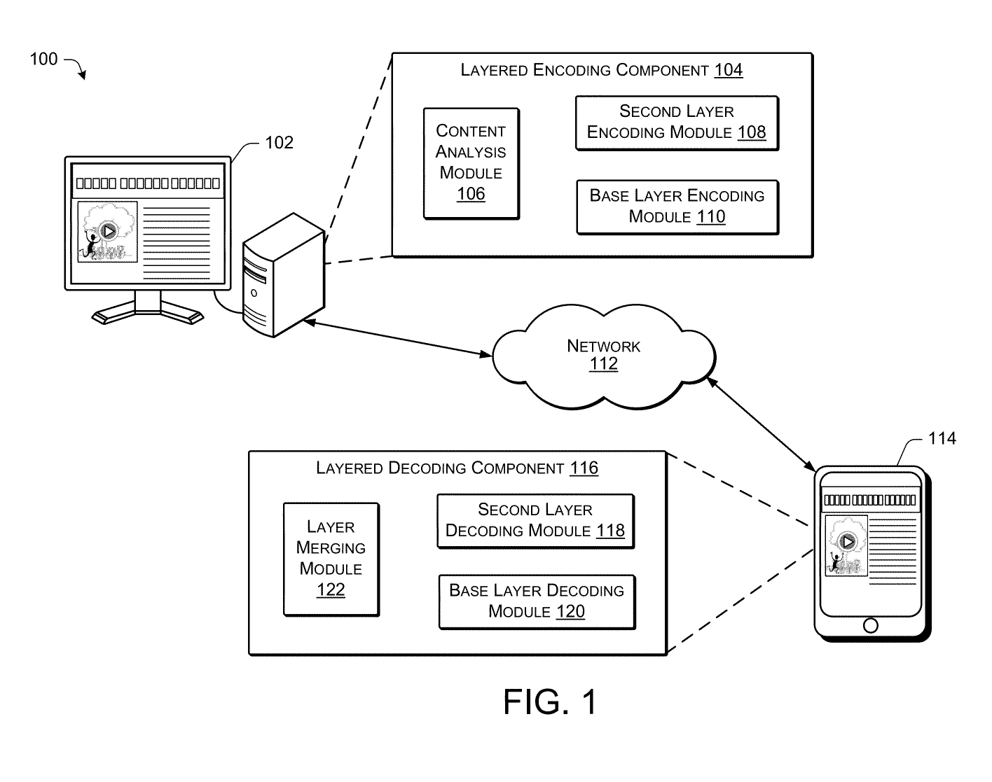

FIG. 1 illustrates an example computing environment 100 in which the layered encoding component and layered decoding component may be implemented. In this example environment, computing device 102 includes a display that is displaying an image. The image currently displayed may be one frame of a video stream. In other examples, the image or video stream on a source computer such as computing device 102 may simply be generated without being displayed locally. In other words, in some cases, computing device 102 may simply provide the image or video stream for transmission. Further, computing device 102 may simultaneously provide multiple remote devices with either the same video stream transmission or distinct video stream transmissions.

Further, in this implementation, computing device 102 includes layered encoding component 104, which may include modules such as content analysis module 106, second layer encoding module 108, and base layer encoding module 110. Content analysis module 106 may analyze video frames or image data from a sequence of video frames to determine which video frames are suitable for encoding using a second layer encoding, and which video frames are suitable for encoding using a base layer encoding. Based at least in part on the analysis from content analysis module 106, a video frame may be provided to second layer encoding module 108 or to base layer encoding module 110. After a video frame is encoded using the appropriate encoding module, the encoded video frame may be transmitted across a network, such as network 112. In some implementations, the base layer encoding and second layer encoding may be performed independently and in parallel. Further, in other implementations, the content analysis may also be performed in parallel.

In general, layered encoding component 104 may include multiple encoding modules, where each respective encoding module may be configured to implement a particular encoding technique based on corresponding image characteristics. In other words, the base layer, or first layer, and second layer encoding modules are one implementation, and different and/or additional encoding modules may be used within layered encoding component 104 and different and/or additional and corresponding decoding modules may be used within layered decoding component 116. Further, within any given layer of encoding, different regions of a single video frame may be encoded using different encoding techniques.

Computing device 114 may receive the encoded video frames transmitted from computing device 102. In other examples, computing device 114 may be one of several computing devices receiving encoded video frames transmitted from computing device 102. In this implementation, layered decoding component 116 may process received video frames to reconstruct the video stream being transmitted. For example, layered decoding component 116 may include layer merging module 122, second layer decoding module 118, and base layer decoding module 120. Layer merging module 122 may analyze a video frame and determine whether or not the video frame has been encoded using the second layer encoding or the base layer encoding. Based on this analysis, layer merging module 122 may provide the encoded video frame for decoding to either second layer decoding module 118 or to base layer decoding module 120. The layer merging module 122 may then use the decoded video frame, along with subsequently received and decoded video frames, to create a sequence of video frames in order to reconstruct the video stream transmission. Further, the decoded video frames may have arrived in an arbitrary order, in which case, in some implementations, metadata may be included within the encoded video frames to determine an order in which to arrange the decoded video frames to reconstruct the original video stream transmission. For example, the metadata may specify a position of a given video frame within the overall video stream, or specify a relative position of a given video frame with regard to a reference video frame.

Further, in some cases, the metadata may include a flag or some other indicator that specifies that another given video frame or video frames are to be skipped. The metadata indicating that a video frame may be skipped may be included within a base layer encoded video frame or a second layer encoded video frame. For example, in the case that the frame being skipped is a second layer encoded video frame, the metadata may specify that a reference frame, such as the previous second layer frame is to be used to generate the skipped second layer video frame. Similarly, in the case that the frame being skipped is a base layer encoded video frame, the metadata may specify that a reference frame, such as the previous base layer frame is to be used to generate the skipped base layer video frame. In other cases, instead of metadata specifying a skip frame, a transmission may include, instead of encoded video frame data, a flag or indicating that the received transmission corresponds to a skipped frame in addition to an indication of another video frame to copy in place of the skipped frame.

In some implementations, layered encoding component 104 and layered decoding component 116 may be implemented within a single module or component, and in this way, the encoding and decoding functionality may be available on a single device and may serve to both encode and decode video streams. Further, for some video streams, it may be that none of the video frames are determined to be suitable for anything but a single layer encoding, and in implementations that use more than two types of encodings, it may be that only some but not all of the different types of encodings are used in encoding the frames of a video stream.

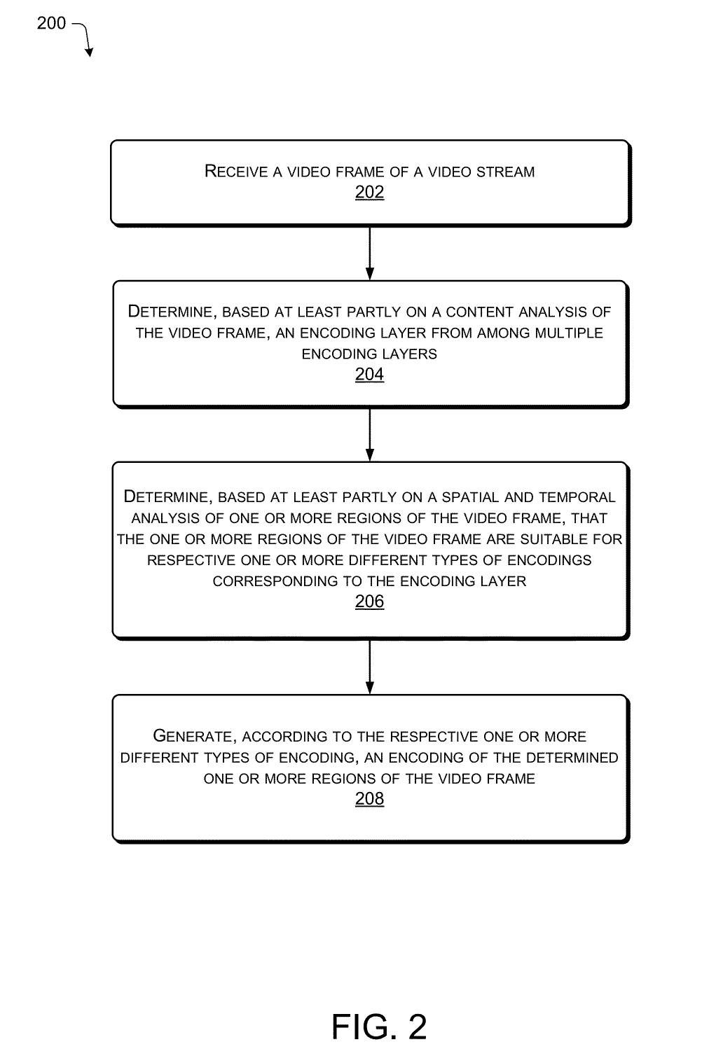

FIG. 2 depicts an example flow diagram 200 that includes some of the computational operations within an implementation of a layered encoding component as it may operate within computing environment 100. Some of the blocks represent operations that can be implemented in hardware, software, or a combination thereof. In the context of software, the blocks represent computer-executable instructions stored on one or more computer-readable media that, when executed by one or more processors, perform the recited operations.

In this implementation, a layered encoding component, such as layered encoding component 104, may receive a series of video frames for a video stream. For example, a single video frame of the video stream may be received to be processed by the layered encoding component prior to transmission, as depicted at 202. In this example, content analysis module 106 may analyze content within the video frame and based at least in part on the content analysis of the video frame, determine an encoding layer to use for encoding the video frame, where the encoding layer may be one of several encoding layers, as depicted at 204. For example, based on the content analysis performed with content analysis module 106, the content analysis module 106 may determine whether second layer encoding module 106 or base layer encoding module 110 is to be used to generate an encoding of the video frame.

In different implementations, a video frame may be divided into blocks or regions in different ways. For example, a video frame may be divided into regions of pixels or blocks of pixels of any shape. Further, video frames may be of any arbitrary dimension, and the division into regions of the video frames may result in different sized regions for different sized video frames. In some cases, if a video frame is 640×480 pixels, the regions may be blocks of 10×10 pixels, or blocks of 16×16 pixels, or blocks of some other dimension. In other implementations, for a given video frame determined to be encoded using one or more second layer encodings, respective encodings of different subregions of the video frame may be defined according the bounds of encoded content within a particular subregion. For example, if the video stream is web page, and the web page includes a video, then the amount of space or pixels used within the web page for displaying the video may be serve as a basis for the dimensions of a region for using a suitable encoding. In this example, the content analysis module 106 may determine the region or regions based on visual characteristics of the video frame contents. In other examples, the dimensions of the regions or blocks for a given video frame may be defined prior to an encoding or decoding.

After the content analysis module 106 has determined whether the video frame is to be processed by either a base layer encoding or a second layer encoding, the video frame may be provided to either base layer encoding module 110 or second layer encoding module 108. For example, the content analysis module 106 may perform a spatial and/or temporal analysis of one or more regions of the video frame, and based at least partly on this analysis, the content analysis module 106 may determine that one or more regions of the video frame are suitable for either the base layer encoding or the second layer encoding, as depicted at 206. Further, depending on whether the content analysis module 106 determines that the base layer encoding or the second layer encoding is suitable for the video frame, one or more of the types of encodings that correspond to the determined layer may be used to encode the video frame. A more complete discussion of temporal and spatial analysis is provided below.

To further this example, if the content analysis module 106 determines that the second layer encoding is suitable for the video frame, then the second layer encoding module 108 may generate, according to one or more of the types of encoding corresponding to the second layer, an encoding of the previously determined one or more regions of the video frame to be encoded, as depicted at 208. As will be discussed below, the second layer encoding module 108 may determine and select one of several encoding techniques to generate a second layer encoding, where the determined technique or techniques may be partly based on the analysis of the image content of the video frame performed by the content analysis module 106 and/or additional content analysis performed by the second layer encoding module 108.

In some implementations, the layered encoding component may also generate and include metadata within a transmission of an encoded video frame. For example, given that less than all regions of a video frame may be encoded with a second layer encoding, a transmission of the video frame may also include metadata indicating which region or regions have been encoded along with information specifying a respective encoding technique applied to a respective region or regions of the video frame. Video frames that have been encoded with a base layer encoding may also include metadata identifying the encoding technique used or identifying that the video frame is to be skipped.

In this example, to decode a video frame encoded with a second layer encoding, the region or regions that have been encoded may be combined with regions from other surrounding video frames in order to generate a full video frame will all regions defined. In some cases, included metadata may specify which other frames to be used as the basis for generating a full video frame from the region or regions encoded with the second layer encoding. The metadata may also specify the size, shape and/or location of the region or regions of the video frame encoded. In some implementations, the layered encoding component may generate a base layer encoding using an industry standard codec, for example, MPEG-2, or H.264, or some other type of encoding. In some cases, an industry standard codec may be used in generating an encoding for one or more regions of a second layer encoding.

In this example, at this point, a video frame has been encoded and the layered encoding component may then transmit the encoded video frame or the layered encoding component may provide the encoded video frame to a computer system for transmission.

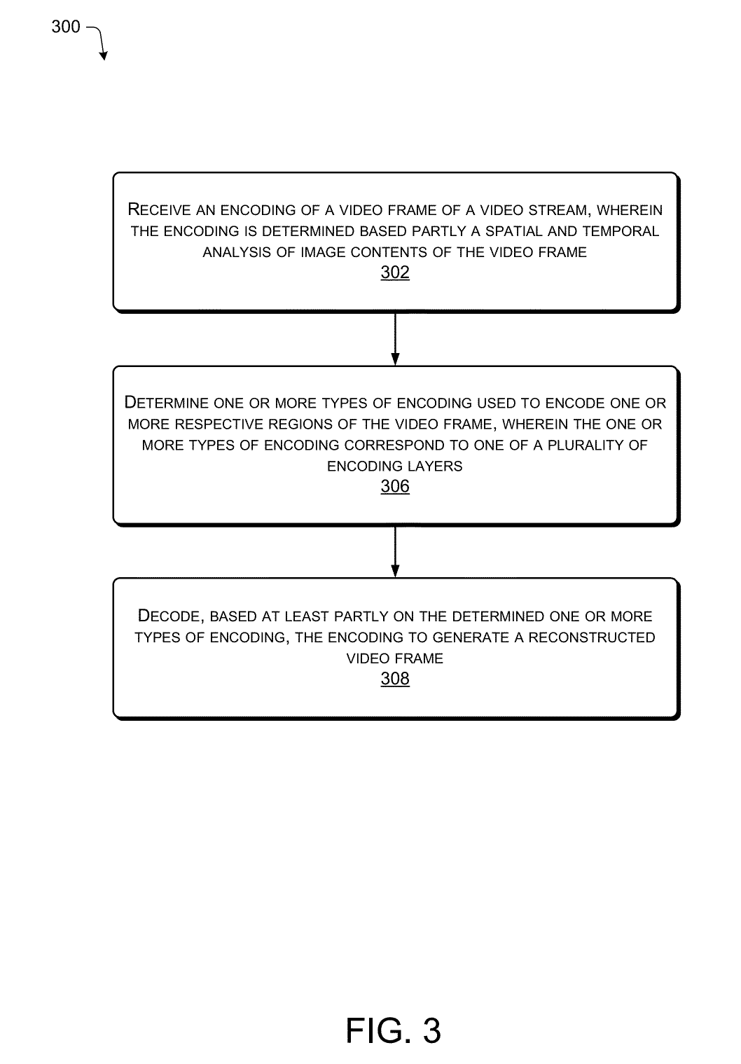

FIG. 3 depicts an example flow diagram 300 that includes some of the computational operations within an implementation of a layered decoding component, as it may operate within computing environment 100. Some of the blocks represent operations that can be implemented in hardware, software, or a combination thereof. In the context of software, the blocks represent computer-executable instructions stored on one or more computer-readable media that, when executed by one or more processors, perform the recited operations.

As noted above in regard to FIG. 1, a device, such as device 114, may be the recipient of a video stream transmitted from a source device. In this example, device 114 includes a layered decoding component, such as layered decoding component 116, which may receive multiple encoded frames as part of the video stream, including receiving a transmission of an encoding of a single video frame, as depicted at 302. Further, the received encoding of the video frame may be encoded based at least partly on a spatial and/or temporal analysis of image contents of the video frame.

As discussed above with respect to FIG. 2, a video frame may be encoded with a base layer encoding or with a second layer encoding. Further, the second layer encoding may encode only some, but not all, of the regions of a video frame, where different regions may be encoded with different types of encoding. Given such an encoded video frame, the layered decoding component may determine the one or more different types of encoding used to encode one or more respective regions of the video frame, where the different types of encoding are types of encoding that correspond to one of the encoding layers, as depicted at 306. In this example, the decoding layers may be the base layer decoding and the second layer decoding, and the determination may be based at least partly on metadata included with the encoded video frame.

After the different types of encoding have been determined for the video frame, the layered decoding component may decode the encoding of the video frame to generate a reconstructed video frame, where the decoding uses the determined types of encoding used in generating the video frame, as depicted at 308. In this example, the different types of encodings, including an indication of a corresponding region or regions may be specified within metadata included with the encoded video frame. In this example, the metadata included in the encoded video frame transmissions may, in the case of a second layer encoding, specify the location or locations and dimension or dimensions of a region or regions that have been encoded and may further include information to identify a frame against to be used as a basis or reference for generating a full frame.

The layered decoding component may repeat the decoding process for each received encoded video frame transmission of the video stream for as long as the video stream is transmitted. In other words, the video stream may be of a fixed length or a continuous stream of indeterminate length. Given the decoded video frames, the layer merging module 122, may then reconstruct the video stream.

Further, because the second layer encodings usually encode less than all, and often only small regions, of a full video frame, the frame rate at which a video stream may be transmitted may be high and still provide a user with a smoothly displayed video stream without any interruptions due to encoding and decoding the video stream while maintaining high video quality. In some examples, a frame rate may be variable and reach 60 frames per second, or more while providing a non-interrupted video stream display.

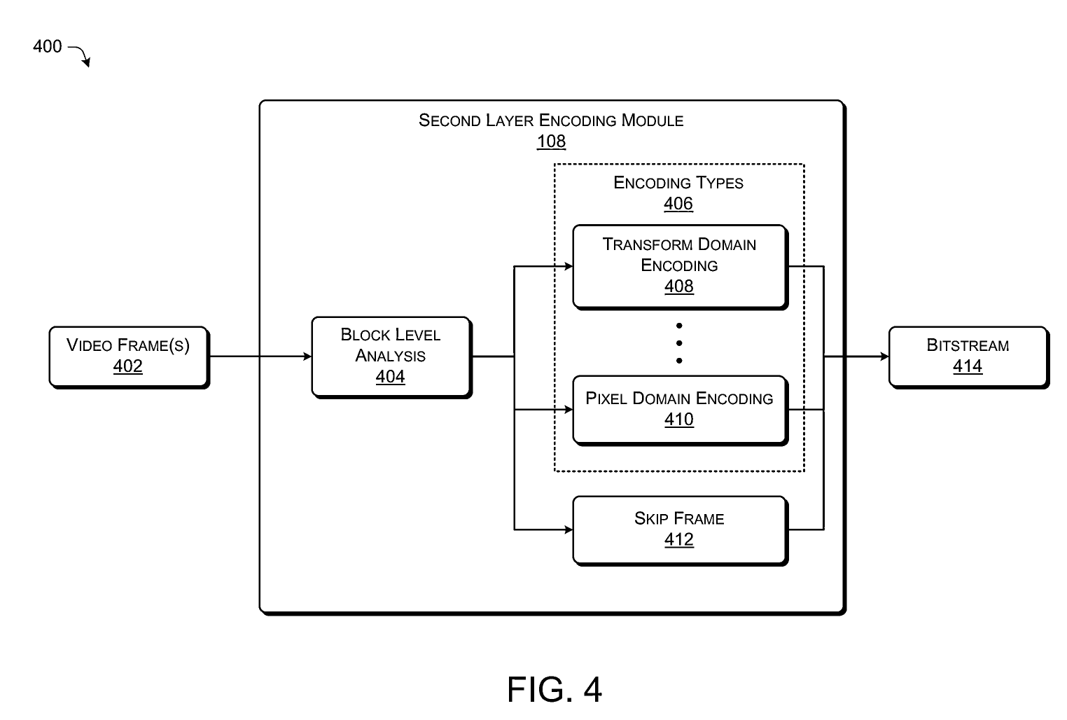

FIG. 4 illustrates a framework 400 depicting additional components that may be included within the example second layer encoding module 108 introduced in FIG. 1. As discussed above with respect to FIGS. 1 and 2, a content analysis module may perform a first analysis on a video frame to determine whether the video frame is to be encoded with a base layer encoding or a second layer encoding. If the content analysis module determines that the video frame is to be encoded with a second layer encoding, then the content analysis module may provide the video frame to a second layer encoding module, as depicted at 402. The video stream information provided to the second layer encoding module may be provided one or more video frames at a time. Otherwise, the video frame may be provided to a base layer encoding module.

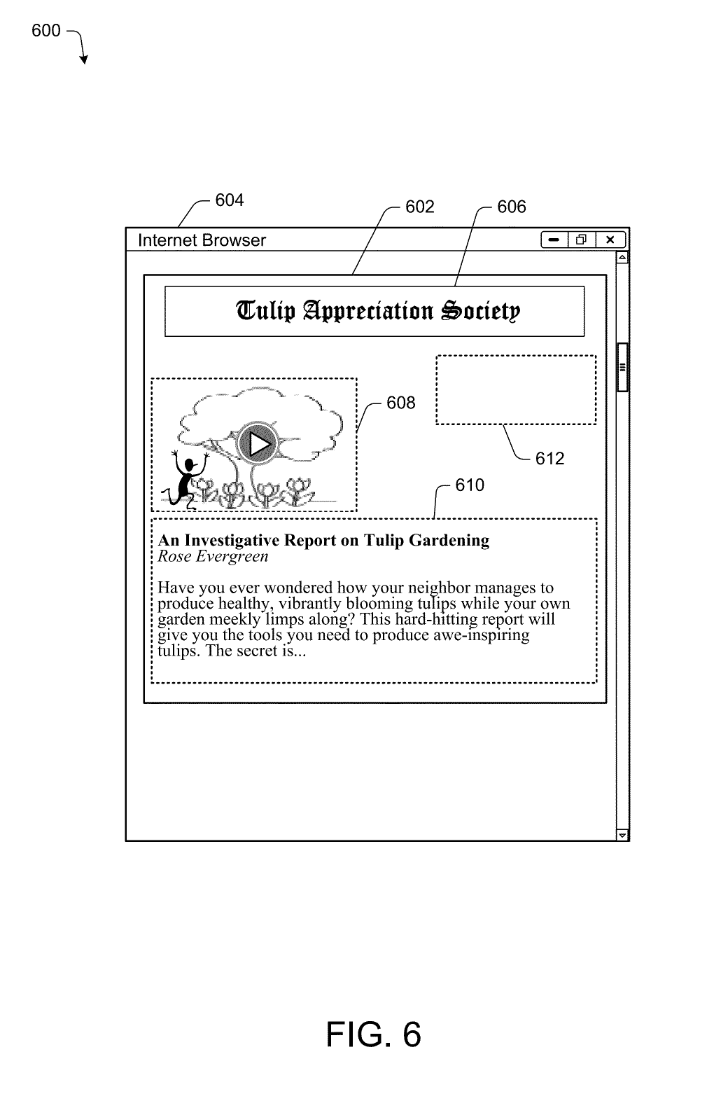

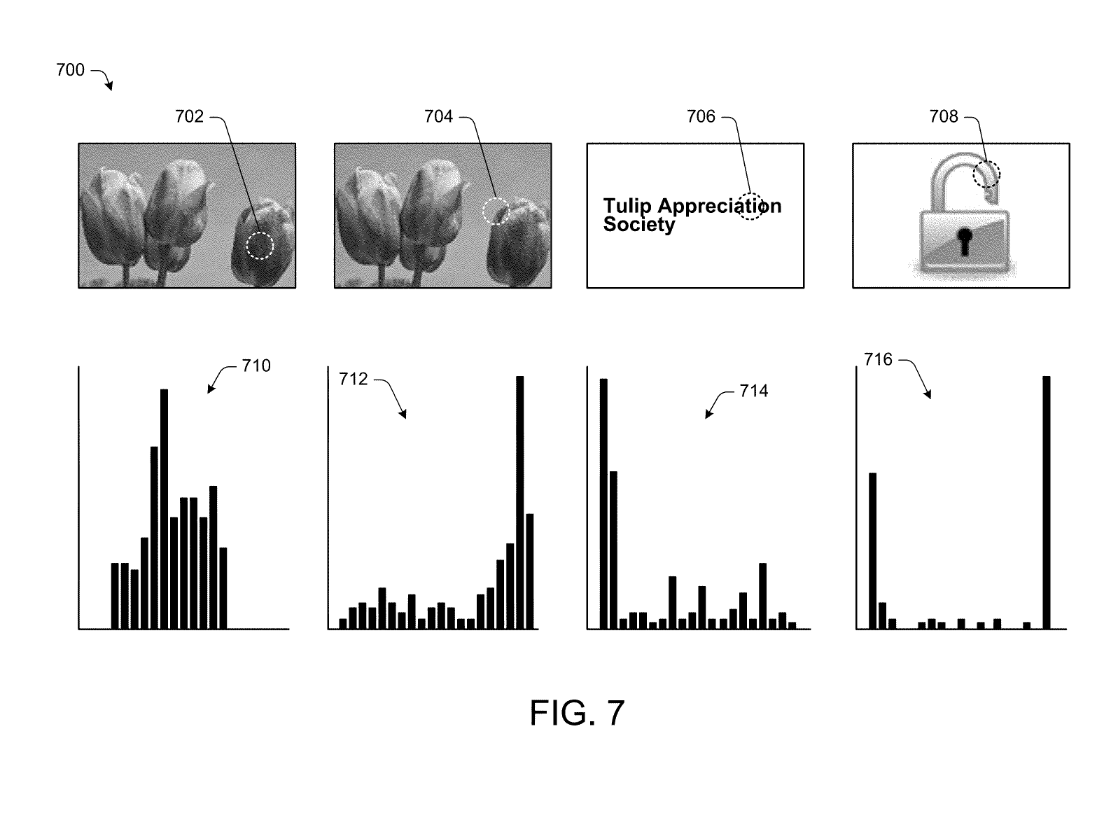

In some implementations, data generated from the analysis performed at the content analysis module may be used by the second layer encoding module. Further, in some examples, the analysis data generated from the content analysis module may be sufficient to determine which of the different types of encodings to use in generating a second layer encoding of the video frame. In other examples, the second layer encoding module may perform a separate, independent analysis of the video frame, or the use both results from the content analysis module and results from a second layer encoding module analysis, such as an analysis performed at 404. As will be discussed below with respect to FIGS. 6 and 7, determining a type of encoding may be based on different types of analysis.

Given an analysis, including a block-level analysis of the video frame, the second layer encoding module may determine a type or types of encoding to use, such as encoding types 406. For example, a given video frame may contain different types of image content, and different types of encoding may be more suitable to maintain a high image quality. In some cases, for regions or blocks within a given video frame that include more complicated textures, such as photographs, a transform domain encoding may be used, such as transform domain encoding 408. In other cases, for regions or blocks within a given video frame that include high contrast image elements or graphical elements or icons, a pixel domain type of encoding may be used, such as pixel domain encoding 410.

Further, given the analysis, the second layer encoding module may determine that one or more regions or blocks of the second layer encoding can be a skipped, as depicted at 412. A region or block may be skipped due to a level of similarity or due to being identical to a corresponding region or block of a previously analyzed video frame, and in such a case, metadata may specify the one or more regions or blocks that are to be skipped, including a reference video frame from which the skipped regions or blocks may be reconstructed.

In other implementations, additional types of encoding may be used for the same types of image content or for different types of image content. The second layer encoding module may then generate an encoding of a video frame. The second layer encoded video frame may be based on different types of encoding, including skip indications, for the regions or blocks of the video frame. In this way, based at least in part on the type or types of encodings used for generating an encoding of the video frame, including skipped regions or blocks, the second layer decoding module may generate transmission data or a bit stream that includes the second layer encoded video frame, as depicted at 414.

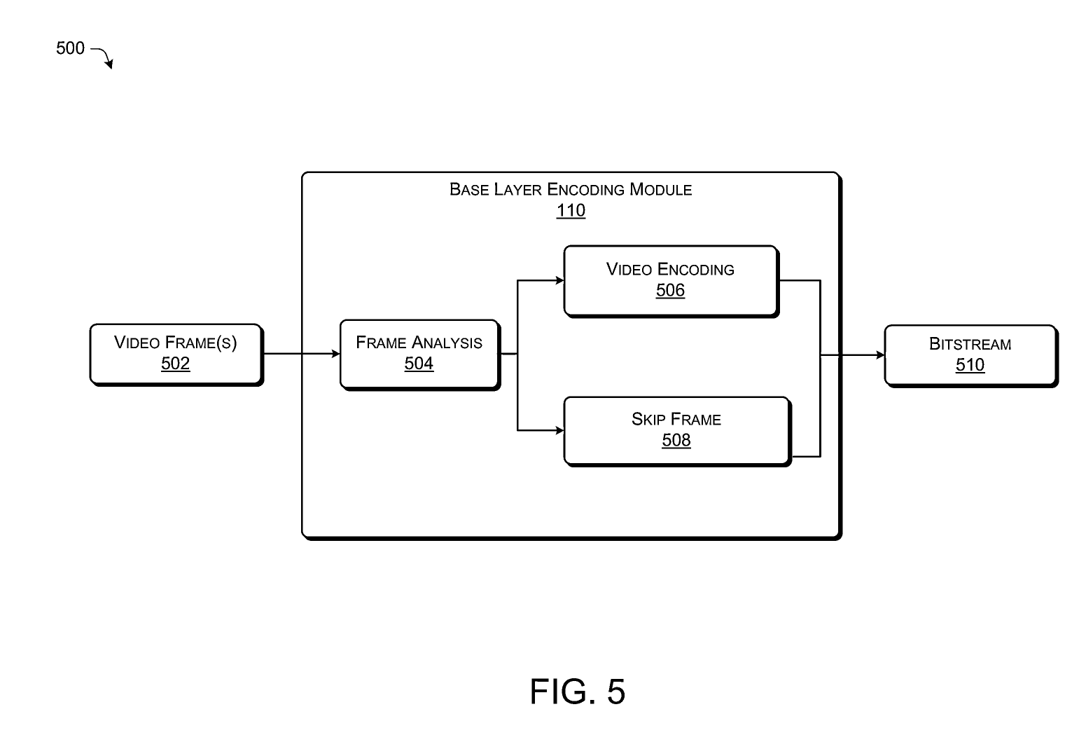

FIG. 5 illustrates a framework 500 depicting additional components that may be included within the example second layer decoding module 110 introduced in FIG. 1. As discussed above with respect to FIGS. 1 and 3, a content analysis module may perform a first analysis on a video frame to determine whether the video frame is to be encoded with a base layer encoding or a second layer encoding. If the content analysis module determines that the video frame is to be encoded with a base layer encoding, then the content analysis module may provide the video frame or frames to a base layer encoding module, as depicted at 502. The video stream information provided to the second layer encoding module may be provided one or more video frames at a time.

In this example, a base layer encoding applies to an entire video frame, where the entire video frame may be encoded according to a particular codec, or where the entire video frame is specified, as a skip frame. A frame analysis may determine whether a given video frame is identical or similar enough to a previous frame to be considered a skip frame or whether the given video frame is to be encoded, as depicted at 504.

Further, in this example, if the frame analysis determines that the video frame is to be encoded, then any traditional codec may be used to encode the entire video frame, as depicted at 506. Otherwise, in this example, if the frame analysis determines that the video frame is identical or similar enough to a previous video frame, then an encoding may include metadata identifying the video frame as a skip frame along with a references frame from which to reconstruct or copy the video frame, as depicted at 508.

The output from the base layer encoding module may be transmission data or a bit stream that includes the base layer encoded video frame, as depicted at 510.

FIG. 6 illustrates a framework 600 depicting a media presentation 602 displayed within a web browser 604, where the media presentation includes different types of images and image data. A streamed media presentation is simply one of many different types of video streaming, and different types of streamed video may be similarly analyzed with the layered encoding component. For example, the media presentation may be transmitted over a network from a server to a client device, and the media presentation may include graphics, such as banner 606, a video, such as video 608, and text, such as text 610. Further, within the media presentation, there may be one or more regions of white space, such as region 612. An analysis of different types of image content is discussed next with respect to FIG. 7.

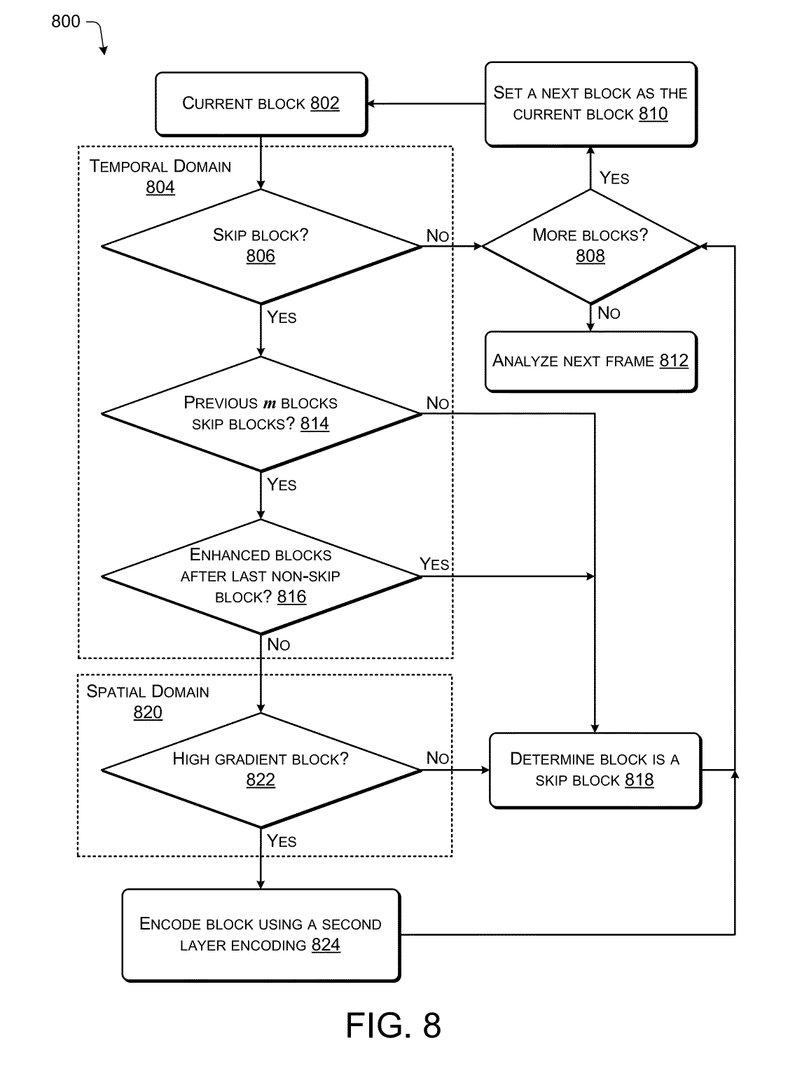

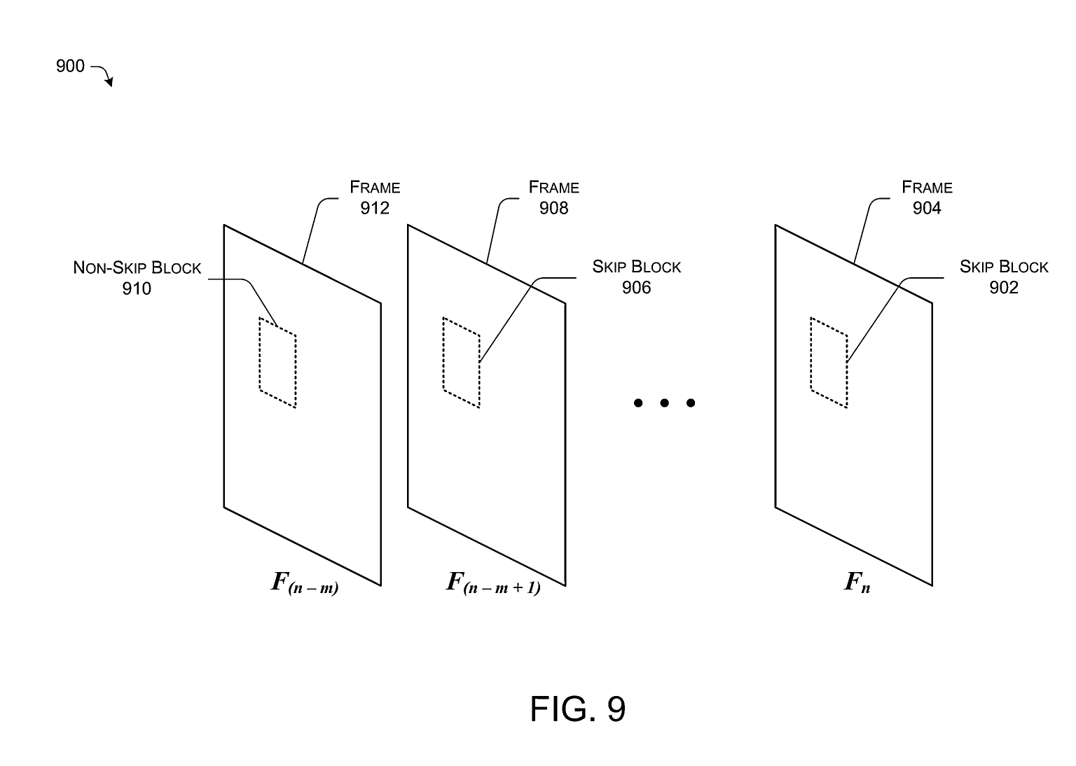

FIG. 7 illustrates a framework 700 depicting different types of images and corresponding luminance histograms. As discussed above with respect to FIGS. 1 and 2, content analysis of a video frame may determine which type of encoding is to be used for the video frame. The content analysis of the visual characteristics of a single video frame may be considered the spatial analysis of a video frame discussed above. Temporal analysis, discussed below with respect to FIGS. 8 and 9, includes an analysis of visual characteristics of corresponding regions or blocks of video frames across multiple video frames.

As depicted in framework 700, there are four example types of image data, where two examples are drawn from the same image. Image region 702 depicts a region of a photograph, where the region is smooth in the sense that there is a level of uniformity and similarity between colors, and where the region does not include any edges. Image region 704 is from the same image from which image region 702 is drawn, however, image region 704 has different visual characteristics. For example, image region 704 includes an edge region depicting the edge of the tulip against the background sky, where an edge or edges may be detected using a variety of methods. Image region 706 includes dark text drawn against a light background, which may be analyzed to be a high contrast feature of the image region. Text may also be determined based at least partly on the sharpness of the edge and/or irregular geometries, for example, as compared to a natural image edge, such as the edge in image region 704. Image region 708 includes a graphical element, which in this case is an icon that includes a several-pixel transition around the edges that include shadow effects, and where the contrast between foreground colors and background colors is higher than edges in natural images.

Further, the human visual system is usually more sensitive to distortions in high-contrast regions as compared to smoother regions. Consequently, in some implementations, when computational resources prevent second layer encoding of all suitable regions without introducing interruptions, the layered encoding component may prioritize high-contrast regions for second layer encoding over smooth regions.

In some implementations, an additional basis for determining the image regions to be encoded in a second layer encoding is whether these image regions, if downsampled, would introduce noticeable degradations in image quality. For example, edges with high contrast edges within image regions 704, 706 and 708 would be noticeably degraded if downsampled.

As discussed above, in some implementations, for a same given image within a video stream, different regions of the image may be encoded using different types of encoding. Luminance histograms 710-716 correspond to the image regions 702-708, respectively. For example, due to high contrast features, luminance histograms 712, 714 and 716 have pixel value bars that may be sparse, may include gaps and/or may include discontinuous distributions. Based on such characteristics of luminance histograms 712, 714 and 716, the layered encoding component may determine that corresponding regions 704, 706, and 708 are to be second layer encoded using a pixel domain encoding. In some cases, these characteristics may be quantified according to, for example, a threshold percentage of change between successive pixel value bars. For example, if some threshold number, say two or more, of drastic changes occur between successive pixel value bars, then the luminance histogram may be determined to correspond to an image region suitable for a second layer encoding, and more specifically, a pixel domain encoding. In different cases, different threshold numbers and percentages may be used. For example, if the threshold difference is outside of a particular range or if the percentage change exceeds a particular percentage. In some examples, a threshold range may be [0,100], and a threshold percentage may be 100 percent; however, other threshold values may be implemented.

By contrast, luminance histogram 710 displays a more continuous distribution of pixel values, and based on this characteristic of the luminance histogram 710, the layered encoding component may determine that corresponding image region 702 is to be second layer encoded using a transform domain encoding. For example, using the example threshold values described above to determine a pixel domain encoding for a given image region, if the luminance histogram is not determined to encode an image region according to a pixel domain encoding, then the image region may instead be determined to be suitable for, and therefore encoded according to, a transform domain encoding.

Further, if each of the regions of a video frame is analyzed and determined to have a luminance histogram similar to luminance histogram 710, then, for example, a content analysis module within a layered encoding component may determine that the entire video frame is to be base layer encoded.

FIG. 8 depicts an example flow diagram 800 that includes some of the computational operations within an implementation of a layered encoding component, as it may operate to perform temporal and spatial analysis on a series of video frames.

Different types of video content may have different types of visual characteristics, for example, video of a computer screen may have characteristics in both the temporal and spatial domains. In the temporal domain, the content of screen video, as compared to natural video, is more stable. This stability in screen video may be due to users looking at the same content for periods of time, for example, while a user reads content and/or decides what to do next with the screen video content. Further, the layout of screen video is often consistent across multiple video frames, for example, if the screen video includes a user interface, then elements that are part of the user interface such as menu bars and scroll bars often remain unchanged for periods of time. In some cases, for example, when a user is scrolling through content, the images presented in the screen video often move with a global motion between neighboring video frames.

In some implementations, the temporal impact of video content on video quality is determined by stability of the video content or the duration the video content is displayed. This temporal impact of stability on video quality may be based on quality enhancements introduced to an encoding of a first video frame being preserved in subsequent video frames in which the same content is present. Natural video lacks similar content stability and any enhanced encoding, such as the second layer encodings, would not have an appreciable impact on video quality. Therefore, in some implementations, stable video content is identified and determined to be encoded with second layer encodings, where the second layer encoding may be performed once at the beginning or near the beginning of a stable period and where the video quality improvements span the duration of the stable period of the video stream.

An analysis to determine a stable region may begin with an analysis of a current block of a video frame from a video stream, as depicted at 802. In this example, in determining whether or not a current block is suitable for second layer encoding based on temporal characteristics, the determinations within temporal domain 804 may be performed. In this example, the first determination within the temporal domain is whether or not the current block is a skip block, as depicted at 806. A block may be considered a skip block if a corresponding block from a previous video frame is identical or sufficiently similar. In this example, if the current block is not a skip block, then the current block is not determined to be suitable for second layer encoding based on temporal characteristics, and a next block in the current video frame may be analyzed. In this regard, if there are more blocks in the current video frame then a next block is selected as the current block and the temporal domain analysis continues.

In this example, the determination of whether there are additional blocks in the current frame is depicted at 808, the setting of a next block as the current block is depicted at 810, and if there are no more blocks in the current frame, a next video frame is analyzed, as depicted at 812. In this example, if the current block is a skip block, then a determination may be made as to whether the previous m corresponding blocks from the previous m video frames have also been skip blocks, as depicted at 814.

Next in this example, if the previous m corresponding blocks for the previous m video frames are skip blocks, then a determination may be made as to whether a block has been second layer encoded or enhanced after the last non-skip block, as depicted at 816. In this example, if a block has been second layer encoded after the last non-skip block, then the current block is determined to be a skip block, as depicted at 818, and processing may continue for a next block, if any, as depicted at 808. Otherwise, if a block has not been second layer encoded after the last non-skip block, then the current block is analyzed for second layer encoding based on spatial characteristics, and the analysis under temporal domain criteria may be complete for the current block.

Within the spatial domain analysis, as depicted at 820, a determination may be made as to whether the current block is a high gradient block, as depicted at 822. As discussed above with respect to FIGS. 6 and 7, different types of analysis may be used in determining whether a current block is suitable for second layer encoding based at least partly on a spatial analysis. In this example, if the current block is determined to be a high-contrast block, such as would be the case for text or a graphic, then the current block may be encoded with a second layer encoding, as depicted at 824, and processing may continue to the next block, if any, as depicted at 808. Otherwise, if the current block is not determined to be a high-contrast block, then the current block may be determined to be a skip block, as depicted at 818, and analysis may continue to the next block, if any, as depicted at 808.

In this manner, in this example, each of the blocks for a current video frame may be analyzed under temporal and spatial considerations of the contents of the video frame. Further, this temporal and spatial analysis of the contents of video frames allows the layered encoding component to use second layer encoding, which may be more processor intensive, for those regions of video frames where any degradations in video quality would be most noticeable. This efficient use of second layer encoding results in maintaining high video quality, while preventing any pauses or interruptions when streaming video content between devices.

FIG. 9 depicts an example framework 900 that illustrates content selection in a temporal domain analysis, such as the analysis discussed above with respect to FIG. 8. As discussed above, a determination may be made as to whether the previous m corresponding blocks for the previous m video frames are skip blocks, as depicted at 816. For example, for a given block, block 902, within, say, the n^{th} video frame, frame 904, the given block may be determined to be a skip block, where the previous corresponding blocks at the same position in the previous (m−1) video frames have been skipped. In other words, the corresponding blocks from video frame Fₙ to F₍ₙ₋ₘ₊₁₎ have been determined to be skip blocks, where block 906 within video frame 908 corresponds to block 902 within video frame 904. In this example, if no corresponding block is determined to be suitable for second layer encoding after the nearest non-skip block, block 910 within video frame 912, in the (n−m)^{th} video frame, video frame 912, then block 902 satisfies the temporal domain analysis and may be considered for spatial domain analysis, as depicted at 822. Otherwise, block 902 is determined to be a skip block, as depicted at 818.

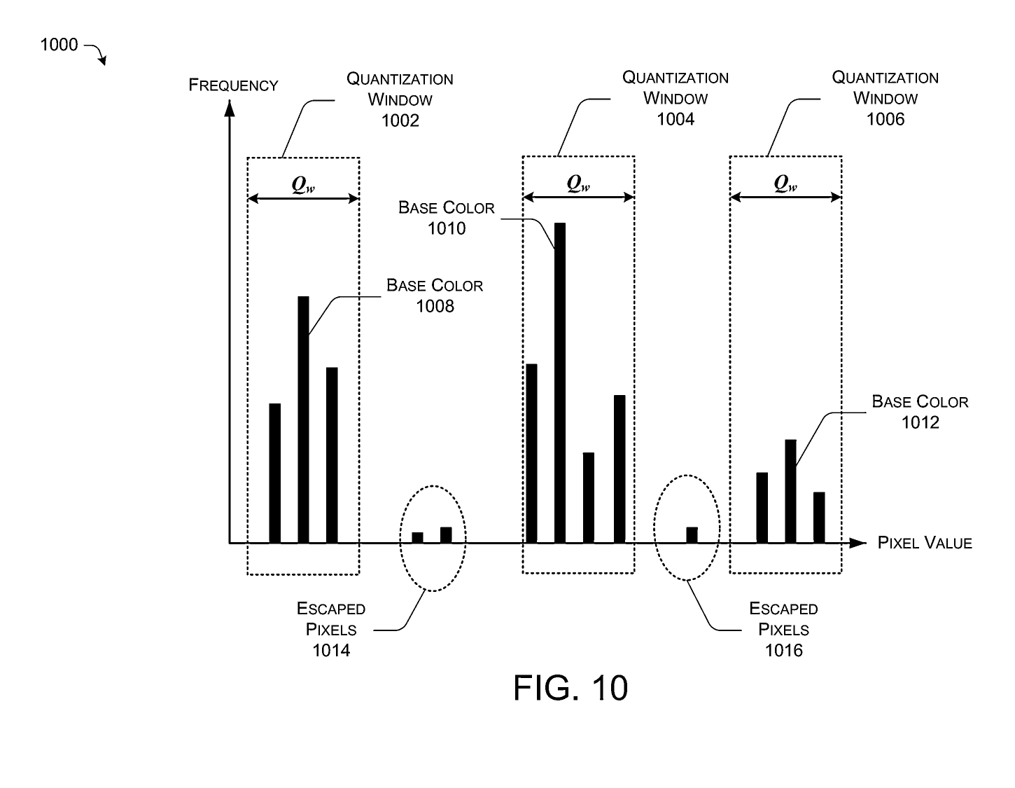

FIG. 10 depicts an example luminance histogram 1000, similar to the luminance histograms discussed above with respect to FIG. 7. As discussed above, a luminance histogram may be used to determine a type of encoding to use in a second layer encoding. In generating an encoding, a luminance histogram may be used, for example, to select base colors. Generally, groups of histogram values may be determined based at least in part on pixel values that fit within respective quantization windows. In this example, there are three quantization windows that may be used to range the colors near the major colors, where a major color may be considered a pixel color that occurs most frequently within a given quantization window. The three quantization windows in this example are quantization windows 1002, 1004 and 1006, where each of these quantization windows are of width Q_{w}, and where quantization window 1002 includes a major color depicted as base color 1008, quantization window 1004 includes a major color depicted as base color 1010, and quantization window 1006 includes a major color depicted as base color 1012.

In this example, pixels within a given quantization window may be quantized to the base color within the same quantization window. Further, in this example, pixels outside the range of a quantization window may be considered escaped pixels, such as escaped pixels 1014 and 1016. In some cases, to determine whether or not a block includes text or a graphic suitable for second layer encoding or whether the block includes a natural image, the number of escaped pixels may be compared against a threshold value. In different cases, the threshold value may be set to different levels and the threshold value may be defined prior to receiving a video stream.

In this way, a spatial analysis of video content may be used to determine whether blocks within a video frame are suitable for second layer encoding, and also to determine base color values to use as a basis for the second layer encoding.

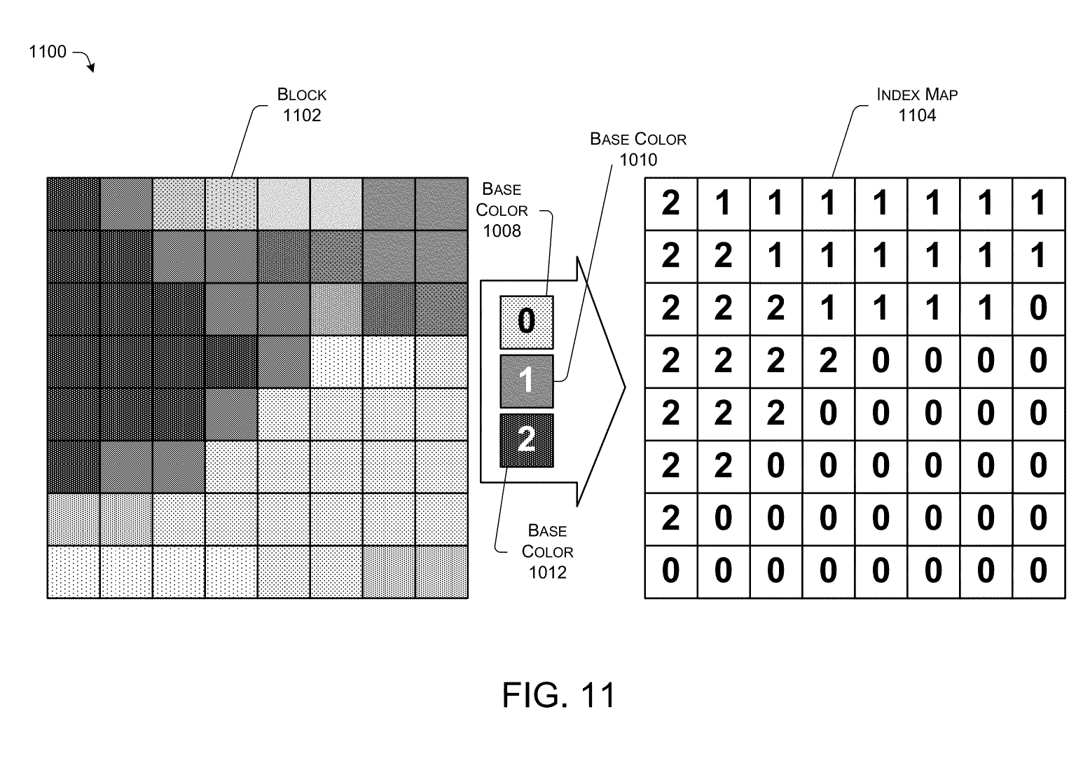

FIG. 11 illustrates a framework 1100 that depicts a mapping between colors in a block within a video frame and an index of base colors. For example, given that block 1102 is the block that serves as a basis for the generation of luminance histogram 1000, then from the discussion above with respect to FIG. 10, the layered encoding component may determine three base colors, base colors 1008, 1010 and 1012. However, within the original block of the video frame, there are many more than three colors, and the layered encoding component may use the three determined base colors as a basis for mapping each pixel color of block 1102 into index map 1104.

For example, for each given pixel color value in block 1102, a determination is made as to which base color is closest in pixel color value, and then the original pixel color is mapped to that base color. In this example, there are three base colors and block 1102 is 8×8 pixels, and the index map is an 8×8 matrix where each entry is a value from 0-2 corresponding to the number of base colors in this example. In other cases, different numbers of base colors may be determined for a given block, and the corresponding index map would include values ranging from 0 to (m−1), where m is the number of base colors. Further, in some implementations, to generate the index map, major color values for a block may be sorted, and then the base color for a given pixel value may be based on a correspondence to a sort of pixel values for a corresponding block in a previous frame since those pixel values in the previous frame have already been mapped.

In some implementations, escaped pixels may be encoded directly with an entropy encoder, and the index map may be compressed using a variable length coding. In this way, the spatial analysis of a block of a video frame may, in addition to serving as a basis for determining whether or not to second layer encode, provide a basis for determining colors and an index mapping to use in the actual encoding.

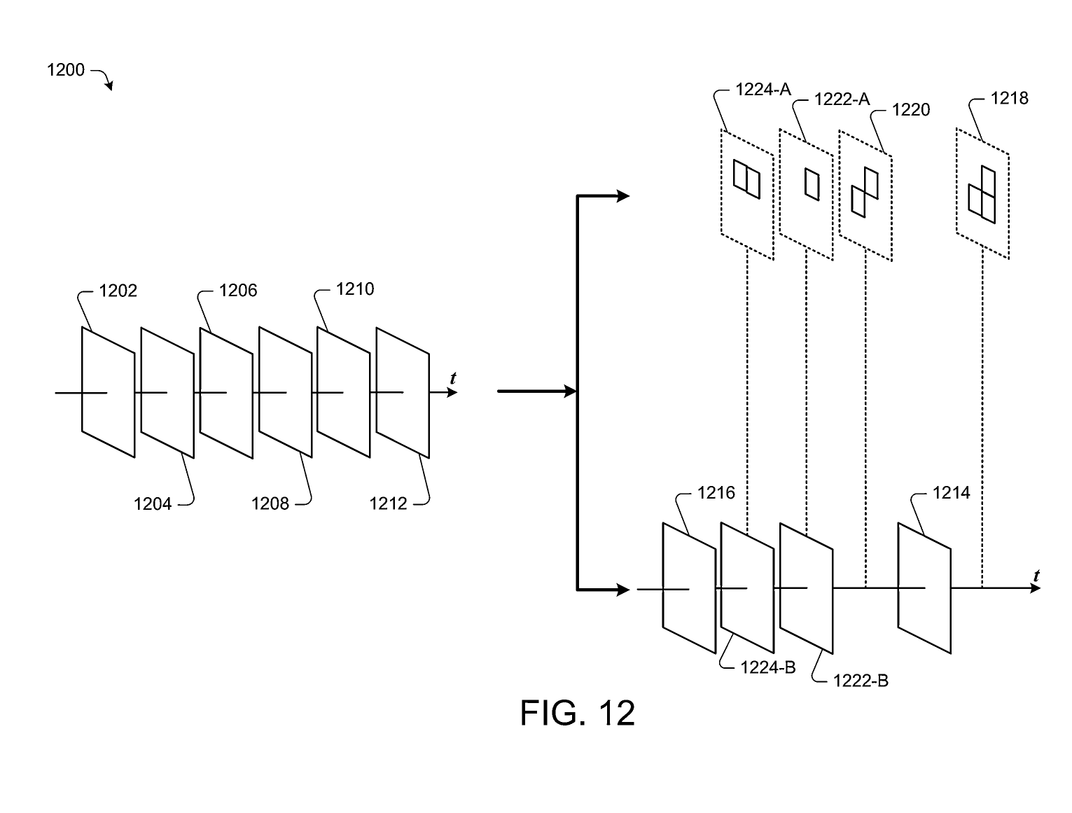

FIG. 12 illustrates a framework 1200 depicting a series of video frames as they exist prior to analysis and separation into multiple encoded layers so that the series of video frames may be encoded and transmitted from a source device to a target device. For example, video frames 1202-1212 may be generated through user interface updates, through a natural video recording, or through some other manner.

In this example, base layer video frames are video frames 1214 and 1216, and second layer video frames are video frames 1218, 1220, 1222 and 1224. Further, the second layer further depicts content selected, or regions selected, to be included within a given video frame encoding.

In some implementations, a position of a region within a second layer encoded video frame may be represented with a binary skip map and losslessly compressed. However, other methods of identifying regions of blocks, including dimensions and locations, of blocks may be used. Further, as discussed above, given an analysis for identifying which regions or blocks are to be included within a second layer encoding, several different types of encodings may be used to generate the second layer encoding.

In some implementations, each of the regions determined to be included within a second layer video frame encoding may be encoded with a traditional video codec, such as H.264, MPEG-2, or some other standard video codec. In this way, dependent upon the video content, a coding scheme optimized for high-contrast regions and smooth backgrounds may be used, such as may be the case when user interfaces are streamed. In such a case, the layered encoding component may determine that the video contents include a shared desktop, or a user interface, and determine that an encoding technique optimized for high-contrast regions and smooth backgrounds be used. As noted above, in some cases an encoding technique such as pixel-domain coding may be used. Otherwise, the layered encoding component may determine that a standard transform-based coding technique is more suitable to be used to encode the second layer video frames.

In this example, the source device may be device 102, and video frames 1202-1212 may be video frames received at a content analysis module of a layered encoding component, such as content analysis module 106 of layered encoding component 104 depicted in FIG. 1. Further, the content analysis module may determine whether a given video frame is suitable for base layer encoding or second layer encoding, where the base layer encoding may be performed by a base layer encoding module such as base layer encoding module 110, and where the second layer encoding may be performed by a second layer encoding module such as second layer encoding module 108.

Further, in this example, the content analysis module may also determine, based at least partly on an analysis of the video frame contents, that original video frames 1210 and 1202 are suitable for a base layer encoding, original video frames 1212 and 1208 are suitable for a second layer encoding, and that original video frames 1206 and 1204 are suitable for both base layer and second layer encoding. For example, when a video frame is both base layer and second layer encoded, the regions to be encoded with the second layer encoding may encode a skip region and the base layer encoding encodes the remaining regions. In this example, the base layer encoding of original video frames 1210 and 1202 correspond to encoded frames 1214 and 1216, respectively; the second layer encoding of original video frames 1212 and 1208 correspond to encoded frames 1218 and 1220, respectively; original video frame 1206 corresponds to second layer encoding 1222-A base layer encoding 1222-B; and original video frame 1204 corresponds to second layer encoding 1224-A and base layer encoding 1224-B. In regard to second layer encodings 1218 and 1220, in some examples, a determination to not perform a base layer encoding may be based at least partly on the corresponding original video frame being the same as, or not significantly different from, a previous original video frame, or based at least partly on the corresponding original video frame having a small ratio of different regions. After the original video frames are analyzed and encoded into base layer encoded video frames and second layer video frames, the layered encoding component may transmit the encoded frames to a target device.

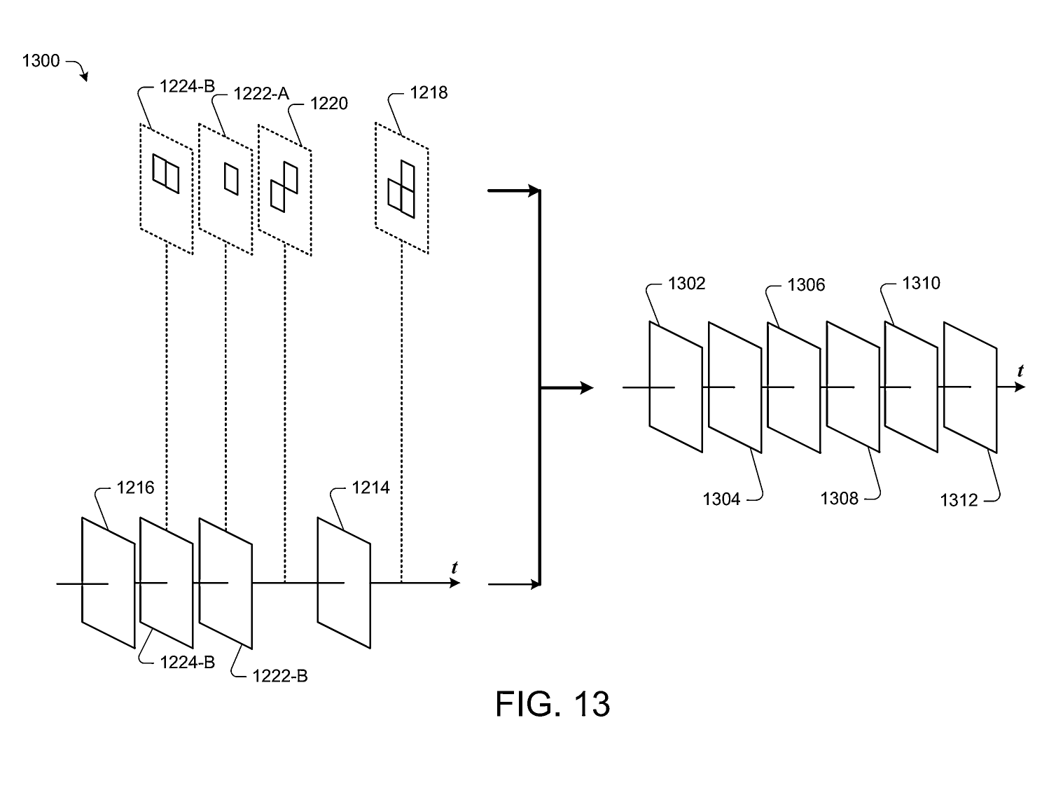

FIG. 13 illustrates a framework 1300 depicting receiving a series of encoded video frames, or encodings, from a source device, where the receiving device, or target device, may analyze the encoded series of video frames with a layered decoding component and generate a reconstructed series of video frames.

For example, the receiving device, or target device, may be device 114, as depicted in FIG. 1, and the received encodings 1218, 1214, 1220, 1222-A, 1222-B, 1224-A, 1224-B and 1216 may be received at a layered decoding component, such as layered decoding component 116, and analyzed with a layer merging module such as layer merging module 122 to determine how to decode the encoded video frames. In some examples, a single encoding may be received in a single data packet or across multiple data packets, and in other cases, multiple encodings may be received in a single data packet. Further, based on the determination by the layer merging module, an encoded video frame may be decoded with a base layer decoding module such as base layer decoding module 120, or an encoded video frame may be decoded with a second layer decoding module such as second layer decoding module 118.

In this example, the layer merging module may determine that encodings 1218 and 1220 have been encoded with a second layer encoding and decode these encoded video frames with a second layer decoding technique or techniques to generate reconstructed video frames. For example, as discussed above, a video frame may be second layer encoded using one or more different encoding techniques. Similarly, the layer merging module may determine that encodings 1214 and 1216 have been encoded with a base layer encoding and decode these encoded video frames with a base layer decoding technique to generate reconstructed video frames. Further, the layer merging module may determine that encodings 1222-A and 1222-B are, respectively, a second layer and base layer encoding of a single video frame, and that encodings 1224-A and 1224-B are, respectively, second and base layer encodings of another single video frame.

Further, in this example, the layer merging module, after the encoded video frames have been decoded, may determine the respective order of the decoded video frames, and based on the respective order, generate a series of reconstructed video frames, as depicted with reconstructed video frames 1302-1312. In this example, reconstructed video frame 1302 corresponds to original video frame 1202; reconstructed video frame 1304 corresponds to original video frame 1204; reconstructed video frame 1306 corresponds to original video frame 1206; reconstructed video frame 1308 corresponds to original video frame 1208; reconstructed video frame 1310 corresponds to original video frame 1210; and reconstructed video frame 1312 corresponds to original video frame 1212.

Further, in this example, a video frame encoded with a second layer encoding, may also include metadata specifying the location and dimensions of the region or regions that have been encoded. In addition, the metadata may specify a reference video frame to serve as a basis for reconstruction an entire video frame. In this example, in decoding a video frame with the second layer decoding algorithm, the layered decoding component would use the region or regions not encoded in the given video frame to determine a corresponding region or regions in a reference video frame in order to reconstruct an entire video frame. In other words, in this example, in reconstructing the given video frame, the layered decoding component would copy all regions of the reference video frame except for the encoded regions of the given video frame, and create an entire video frame from the copied regions of the reference video frame in combination with decoded regions of the given video frame. In this way, in this example, the reconstructed video frames on the target device may display the streaming video transmitted from the source device.

### Illustrative Computer System

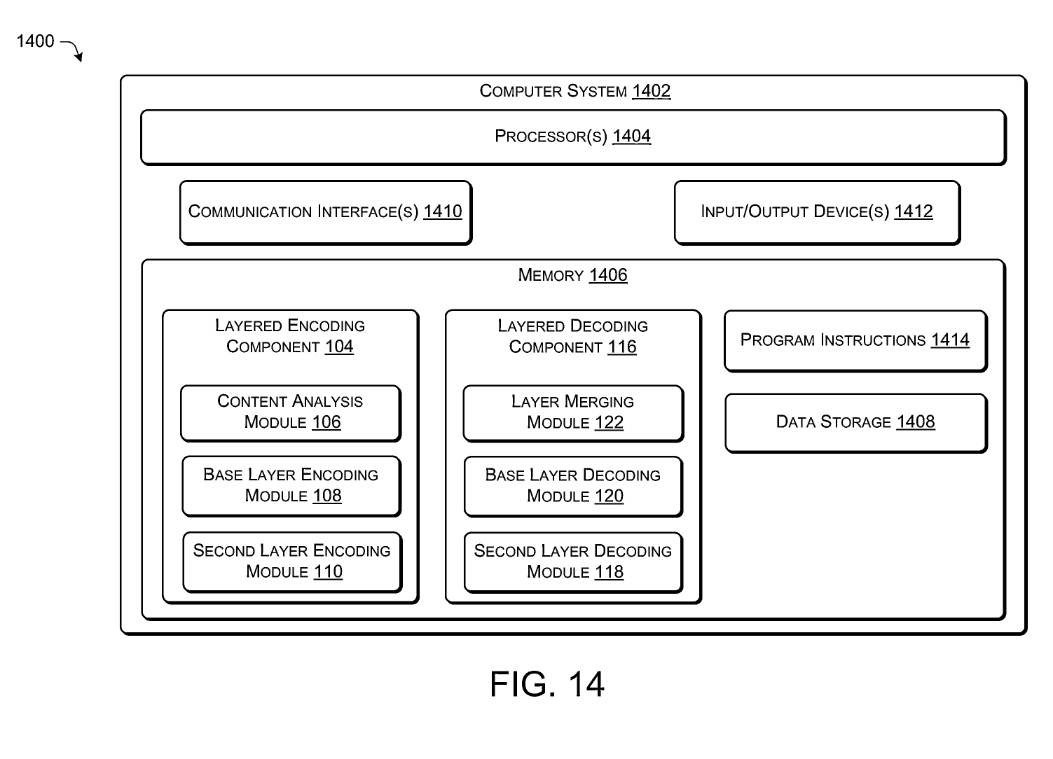

FIG. 14 further illustrates a framework 1400 depicting a computer system 1402. Computer system 1402 may be implemented in different devices, such as device 102 and device 114 depicted in FIG. 1. Generally, computer system 1402 may be implemented in any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a television, a video recording device, a peripheral device such as a switch, modem, router, or in any type of computing or electronic device.

In one implementation, computer system 1402 includes one or more processors 1404 coupled to memory 1406. The processor(s) 1404 can be a single processing unit or a number of processing units, all of which can include single or multiple computing units or multiple cores. The processor(s) 1404 can be implemented as one or more microprocessors, microcomputers, microcontrollers, digital signal processors, central processing units, state machines, logic circuitries, and/or any devices that manipulate signals based on operational instructions. As one non-limiting example, the processor(s) 1404 may be one or more hardware processors and/or logic circuits of any suitable type specifically programmed or configured to execute the algorithms and processes described herein. Among other capabilities, the processor(s) 1404 can be configured to fetch and execute computer-readable instructions stored in the memory 1406 or other computer-readable media. Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

By contrast, communication media may embody computer-readable instructions, data structures, program modules, or other data in a modulated data signal, such as a carrier wave, or other transmission mechanism. As defined herein, computer storage media does not include communication media.

The memory 1406, including data storage 1408, is an example of computer storage media. Further, computer system 1402 may include one or more communication interfaces 1410 that may facilitate communications between computing devices. In particular, the communication interfaces 1410 may include one or more wired network communication interfaces, one or more wireless communication interfaces, or both, to facilitate communication via one or more networks represented by a network, such as network 112. The network 112 may be representative of any one or combination of multiple different types of wired and wireless networks, such as the Internet, cable networks, satellite networks, wide area wireless communication networks, wired local area networks, wireless local area networks, public switched telephone networks (PSTN), and the like.

Additionally, computer system 1402 may include input/output devices 1412. The input/output devices 1412 may include a keyboard, a pointer device, (e.g. a mouse or a stylus), a touch screen, one or more image capture devices (e.g. one or more cameras), one or more microphones, such as for voice control, a display, speakers, and so forth.

In some implementations, the invention may be implemented using a single instance of a computer system, while in other implementations, the invention may be implemented on multiple such systems, or multiple nodes making up a computer system may be configured to host different portions or instances of implementations. For example, in one implementation some elements may be implemented via one or more nodes of the computer system that are distinct from those nodes implementing other elements.

The memory 1406 within the computer system 1402 may include program instructions 1414 configured to implement each of the implementations described herein. In one implementation, the program instructions may include software elements of implementations of the modules discussed herein. The data storage within the computer system may include data that may be used in other implementations.

Generally, computer-executable instructions include routines, programs, objects, components, data structures, and the like that perform particular functions or implement particular abstract data types. The order in which the operations are described is not intended to be construed as a limitation, and any number of the described blocks can be combined in any order or in parallel to implement the processes

### CONCLUSION

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
one or more computing nodes, each comprising at least one processor and memory, wherein the one or more computing nodes are configured to implement an encoding component and a decoding component,
wherein the encoding component is configured to:
determine, based at least partly on a content analysis of a video frame of a video stream, an encoding layer from among a plurality of encoding layers;
determine, based at least partly on a spatial and temporal analysis of one or more regions of the video frame, that the one or more regions of the video frame are suitable for respective one or more different types of encoding corresponding to the encoding layer; and
generate an encoding of the one or more regions of the video frame according to the respective one or more different types of encoding; and
wherein the decoding component is configured to:
determine the one or more different types of encoding corresponding to the encoding of the video frame; and
decode, based at least partly on the one or more different types of encoding, the encoding to generate a reconstructed video frame.

2. The system as recited in claim 1, wherein to generate the encoding of the one or more regions of the video frame, the encoding component is further configured to not base the encoding on a region or regions other than the determined one or more regions of the video frame.

3. The system as recited in claim 1, wherein to generate the encoding of the one or more regions of the video frame, the encoding component is further configured to encode a first region of the determined one or more regions of the video frame with a pixel-domain coding technique and to encode a second region of the determined one or more regions of the video frame with a transform-based coding technique.

4. The system as recited in claim 1, wherein to generate the reconstructed video frame, the decoding component is further configured to:
receive a plurality of encoded video frames;
decode, based at least partly on one or more respective types of encoding corresponding respective video frames of the plurality of encoded video frames, the plurality of encoded video frames to generate a plurality of reconstructed video frames; and
generate a video stream based at least partly on the plurality of reconstructed video frames.

5. A method comprising:
under control of one or more computing devices configured with executable instructions:
receiving a video frame of a video stream;
determining, based at least partly on a content analysis of the video frame, an encoding layer from among a plurality of encoding layers;
determining, based at least partly on a spatial and temporal analysis of one or more regions of the video frame, that the one or more regions of the video frame are suitable for respective one or more different types of encoding corresponding to the encoding layer; and
generating an encoding of the determined one or more regions of the video frame according to the respective one or more different types of encoding.

6. The method as recited in claim 5, wherein the spatial analysis comprises generating a luminance histogram for the one of the one or more regions of the video frame.

7. The method as recited in claim 5, wherein the spatial analysis further comprises determining, based at least partly on a distribution of pixel values within the luminance histogram, one or more base colors for the one or more regions of the video frame.

8. The method as recited in claim 7, wherein the generating the encoding further comprises determining, based at least partly on the one or more base colors for the one or more regions of the video frame, one or more index maps corresponding to the one or more regions of the video frame.

9. The method as recited in claim 8, wherein the plurality of encoding layers comprises a third encoding layer with corresponding encoding techniques that are different from others of the other plurality of encoding layers.

10. The method as recited in claim 5, wherein the generating the encoding further comprises determining metadata specifying a position of the video frame within the video stream.

11. The method as recited in claim 5, wherein the encoding is a first encoding, and wherein the generating the first encoding and generating a second encoding are performed in parallel.

12. The method as recited in claim 5, wherein the generating the encoding comprises generating metadata specifying a size and location for each of the one or more regions of the video frame.

13. The method as recited in claim 5, wherein the generating the encoding comprises generating metadata specifying one or more encoding techniques used in generating the first encoding.

14. The method as recited in claim 5, wherein the generating the encoding comprises generating metadata specifying one or more skip regions and a reference video frame upon which to at least partly base a reconstruction of the video frame.

15. The method as recited in claim 5, wherein the temporal analysis comprises, for a given region of the one or more regions, determining that a threshold number of previous video frames have been skip regions, wherein the skip regions correspond to the given region of the one or more regions.

16. The method as recited in claim 15, wherein the temporal analysis further comprises determining that a region for a previous video frame was not skipped, wherein the region for the previous video frame corresponds to the given region of the one or more regions, and wherein there are a threshold number of video frames between the previous video frame and the video frame.

17. A method comprising:
performing, by one or more computing devices:
receiving an encoding of a video frame of a video stream, wherein the encoding is determined based partly on a spatial and temporal analysis of image contents of the video frame;
determining one or more types of encoding used to encode one or more respective regions of the video frame, wherein the one or more types of encoding correspond to one of a plurality of encoding layers; and
decoding, based at least partly on the determined one or more types of encoding, the received encoding to generate a reconstructed video frame.

18. The method as recited in claim 17, wherein generating the reconstructed video frame comprises:
extracting, from the first encoding, metadata specifying a size and location for each of one or more respective regions of the video frame, wherein the metadata further specifies a reference video frame; and
generating, at least in part, the reconstructed video frame from the one or more respective regions combined with one or more regions from the reference video frame.

19. The method as recited in claim 17, wherein at least one of the regions of the respective one or more regions of the video frame is encoded with a first encoding technique, wherein at least one of the regions of the respective one or more regions of the video frame is encoded with a second encoding technique, and wherein the first encoding technique is different from the second encoding technique.

20. The method as recited in claim 17, wherein the decoding the encoding further comprises:
extracting, from the encoding, metadata specifying respective encoding techniques used to encode the one or more respective regions of the video frame; and
decoding the encoding according to the respective encoding techniques.
